(19) United States
(12) Patent Application Publication
(10) Pub. No.: US 2020/0150514 A1
(43) Pub. Date: May 14, 2020

(54) EXTENDED STRUCTURE FOR USE WITH A TRIPOD

(71) Applicant: Shenzhen Youbaise Technology Co., Ltd., SHENZHEN (CN)

(72) Inventor: DINGLAN LI, SHENZHEN (CN)

(73) Assignee: Shenzhen Youbaise Technology Co., Ltd.

(21) Appl. No.: 16/184,459

(22) Filed: Nov. 8, 2018

(51) Int. Cl. G03B 17/56; F16M 11/12

(52) U.S. Cl. CPC G03B 17/561; F16M 2200/066; F16M 11/126

(57) ABSTRACT

An extended structure comprises at least one fixed piece, a buckle for fixing to the tripod, and at least one connecting member, one end of which is fixed to the buckle, and the other end of which is fixed to the fixing piece. The extended structure facilitates the installation of at least one additional accessory for photographing on a tripod.

### FIELD OF THE INVENTION

The present disclosure relates to extension piece and, more particularly, to extended structure for use with a tripod.

### BACKGROUND OF THE INVENTION

A tripod which generally has only one pan-tilt can support the camera to take pictures. If you need to use other accessories, such as fill light, microphone, and photographic equipment, each accessory needs to be separately set up with a tripod to support the fixing, which is very inconvenient.

### SUMMARY OF THE INVENTION

In view of the problems of the prior art, the primary object of the present disclosure is to provide an extended structure for use with a tripod. It is convenient to install at least one additional accessory for photographing, on the tripod.

In order to achieve the aforesaid object, an extended structure for use with a tripod is provided. It is therefore a primary object of the present disclosure to provide an extended structure for use with a tripod. The extended structure comprising at least one fixed piece, a buckle for fixing to the tripod, and at least one connecting member, one end of which is fixed to the buckle, and the other end of which is fixed to the fixing piece.

Preferably, the connecting member can be bent.

Preferably, the connecting member comprising a rod body made of a material that can be repeatedly bent, one end of which is fixed to the buckle, and the other end of which is fixed to the fixing piece, a sponge nested on the rod body.

Preferably, the fixing piece is a connecting screw fixed to the connecting member.

Preferably, the connecting member is at an angle with respect to the buckle.

Preferably; the extended structure comprising two connecting members, and the two connecting members are symmetrically disposed on both sides of the buckle.

Preferably, the connecting member is detachably connected to the buckle.

Preferably, the buckle is provided with a screw hole, and an end of the connecting member is provided with a screw, and the screw is matched with the screw hole.

Preferably, the buckle comprising a connecting plate provided with a through hole which is fixedly connected with the tripod, a tension adjusting member fixed on the connecting plate for adjusting a size of the through hole, so as to adjust a connection tightness between the connecting plate and the tripod.

Another object of the present disclosure is to provide a tripod. The tripod comprising supporting leg, a mounting seat fixed and supported by the supporting leg, and the extended structure for use with a tripod. The buckle is fixed on the mounting seat.

Compared to the prior art, the extended structure for use with a tripod of the present disclosure has the following benefits. When it is necessary to use an additional accessory for photographing, the extended structure can be fixed on the tripod, and then the additional accessory is fixed by the fixing piece, which is more convenient.

These and other objects of the present disclosure will become apparent to those skilled in the art as the description thereof proceeds.

### BRIEF DESCRIPTION OF THE DRAWINGS

The present disclosure will be described with greater specificity and clarity with reference to the following drawings, in which:

FIG. 1 is an isometric view of an extended structure for use with a tripod of one embodiment in the present disclosure;

FIG. 2 is a front schematic view of a tripod with the extended structure of one embodiment in the present disclosure;

FIG. 3 is an isometric view of a connecting member of the extended structure for use with a tripod of one embodiment in the present disclosure;

FIG. 4 is a schematic diagram of the decomposition of the connecting member in FIG. 3;

FIG. 5 is an isometric view of a buckle of the extended structure for use with a tripod of one embodiment in the present disclosure.

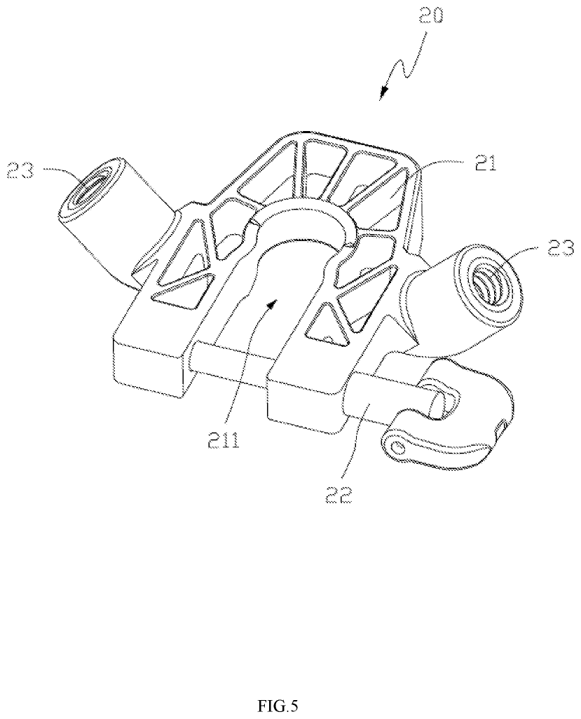

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

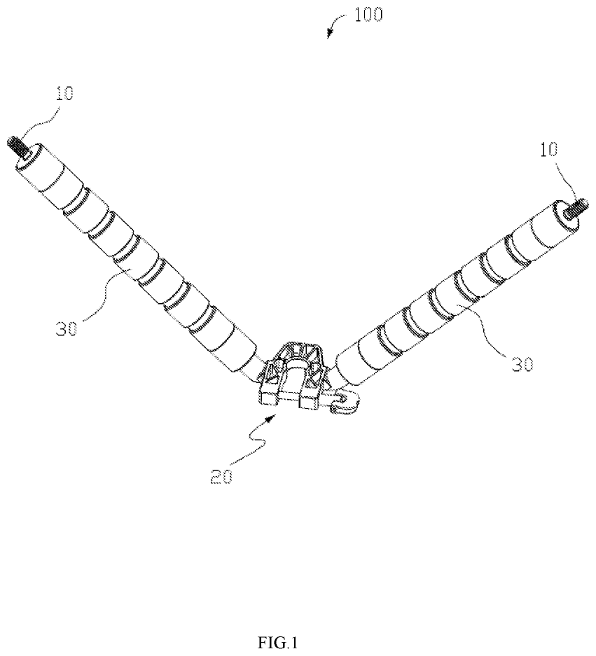

Referring to FIG. 1, there is shown an extended structure for use with a tripod. The extended structure 100 comprising two fixed pieces 10, a buckle 20 and two connecting members 30, the number of fixing pieces 10 and the connecting members 30 are the same. It should be appreciated that the number of the connecting members 30 can be one or more. The fixing piece 10 which fixed at one end of the connecting member 30 is used for connecting an additional accessory for photographing. The additional accessory for photographing may be LED lights, microphones, card cameras, mobile phones, etc. The other end of the connecting member 30 is fixedly connected with the buckle 20. Two of the connecting members 30 are symmetrically arranged on both sides of the buckle 20.

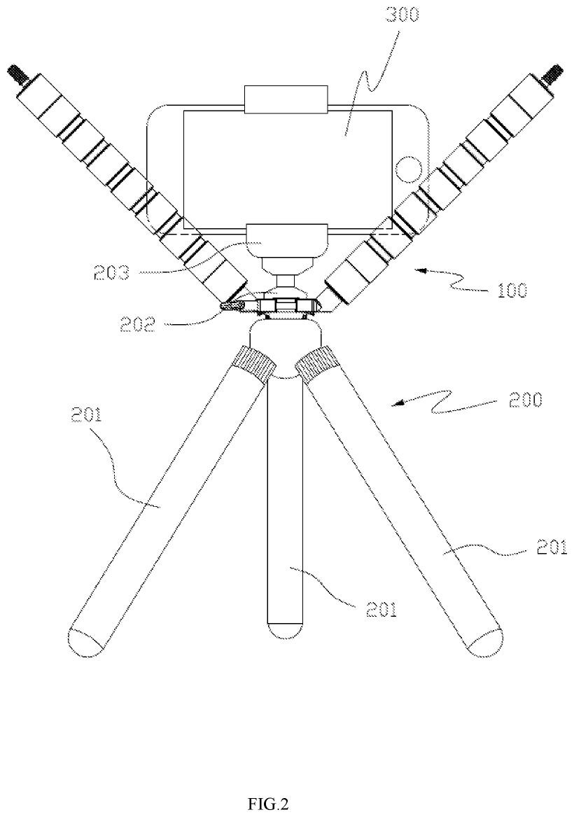

Referring to FIG. 2, there is shown a tripod with the extended structure. Specifically, the tripod 200 may include three supporting legs 201, a mounting seat 202 which is fixed by the three supporting legs 201, and the extended structure 100. A pan-tilt 203 for fixing the photographing device 300 may be fixed to the mounting seat 202. The photographing device 300 can be a mobile phone or a camera, etc.

In use, the user may fix the buckle 20 on the mounting seat 202 at first, then fix the photographing device 300 on the pan-tilt 203, and fix the additional accessory for photographing on the fixture piece 10 at last. Thus, at least two devices can be fixed simultaneously by the tripod 200, one is a photographing device for photographing, and the other is an accessory for photographing. It should be appreciated that a corresponding number of the connecting, members 30 can be provided according to actual needs to fix different types or quantities of accessories.

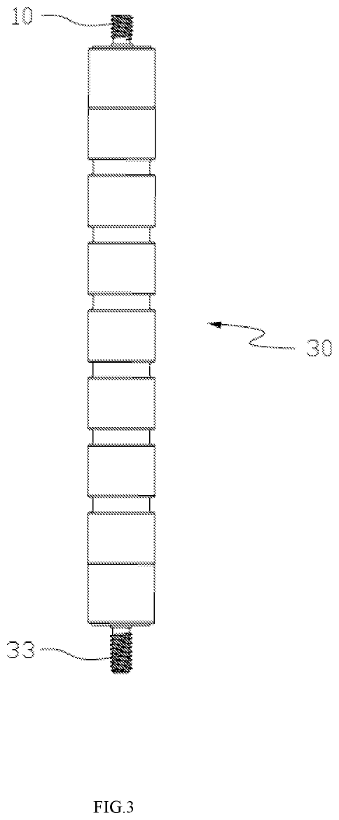

Referring to FIG. 3, there is shown the connecting member. In one embodiment, the connecting member 30 can be bent. The height of the additional accessory and the front and rear position of the additional accessory can be adjusted, so that the distance between the additional accessory and the photographing device 300 can be adjusted by bending the connecting member 30, and the additional accessory can better assist the photographing device 300 in taking a picture.

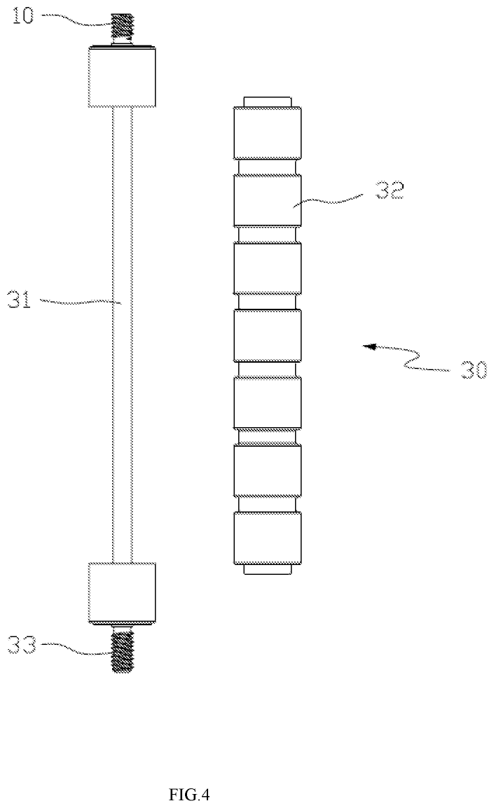

Referring to FIG. 4, FIG. 4 is a schematic diagram of the decomposition of the connecting member in FIG. 3. In one embodiment, the connecting member 30 comprising a rod body 31 made of a material that can be repeatedly bent, and a sponge 32 nested on the rod body 31. One end of the connecting member 30 is fixed to the buckle 20, and the other end of the connecting member 30 is fixed to the fixing piece 10. The sponge 32 can serve as a comfortable handle. The sponge 32 has a certain anti-slip effect, and can protect the rod body 31, so that the connecting member 30 is more beautiful. The sponge 32 can be made by EVA sponge.

The fixing piece 10 is a standard size connecting screw. Using a connecting screw as a connector can simplify the structure and connect a variety of other other structures. Certainly, the fixing piece 10 can also be a pan-tilt or a mobile phone clip. In one embodiment, in order to prevent the photographing device 300 fixed on the pan-tilt 203 from occluding the additional accessory fixed on the fixture piece 10, the connecting member 30 relative to the buckle 20 at an angle. When the extended structure 100 is fixed on the tripod 200, the fixing piece 10 is stagger with the photographing device 300. When using the additional accessory such as supplementary light or card camera, it can avoid being blocked by the photographing device 300.

Referring to FIG. 4, there is shown the buckle. In one embodiment, the buckle 20 comprising a connecting plate 21 provided with a through hole 211 which is fixedly connected with the tripod 200, a tension adjusting member 22 fixed on the connecting plate 21 for adjusting a size of the through hole 211. When the buckle 20 is fixed on the tripod 200, the connecting portion on the mounting seat 202 is received in the through hole 211. The size of the through hole 211 can be adjusted by screwing the tension adjusting member 22, so that the connection tightness of the connecting plate 21 and the connecting portion on the mounting seat 202 can be adjusted to install the extended structure 100 on the tripod 200 or disassemble the extended structure 100 from the tripod 200.

In one embodiment, the connecting member 30 is detachably connected to the buckle 20. Specifically, the connecting plate 21 of the buckle 20. The connecting plate 21 is provided with a screw hole 23. Referring to FIG. 3 and FIG. 4, an end of the connecting member 30 is provided with a screw 33 having a mating connection with the screw hole 23 to detachably connect the connecting member 30 with the buckle 20 for facilitating replacement of the connecting member 30.

The above only describes preferred embodiments of the present disclosure and is intended to reflect outstanding technical effects and advantages of the present disclosure, not to limit technical solutions of the present disclosure. Those skilled in the art should understand that all modified, changed or replaced technical features based on technical contents of the present disclosure should be included in a technical scope of appended claims in the present disclosure.

The entirety of this disclosure (including the Cover Page, Title, Headings, Field, Background, Summary, Brief Description of the Drawings, Detailed Description, claims, Abstract, Figures, and otherwise) shows by way of illustration various embodiments in which the claimed inventions may be practiced.

I claim:

1. An extended structure for use with a tripod comprising:
at least one fixed piece;
a buckle for fixing to the tripod; and
at least one connecting member, one end of which is fixed to the buckle, and the other end of which is fixed to the fixing piece.

2. The extended structure for use with a tripod as claimed in claim 1, wherein the at least one connecting member can be bent.

3. The extended structure for use with a tripod as claimed in claim 2, wherein the at least one connecting member comprising:
a rod body made of a material that can be repeatedly bent, one end of the rod body is fixed to the buckle, and the other end of the rod body is fixed to the fixing piece;
a sponge nested on the rod body.

4. The extended structure for use with a tripod as claimed in claim 3, wherein the at least one fixing piece is a connecting screw fixed to the at least one connecting member.

5. The extended structure for use with a tripod as claimed in claim 1, wherein the at least one connecting member is at an angle with respect to the buckle.

6. The extended structure for use with a tripod as claimed in claim 1, wherein the extended structure comprises two connecting members, and the two connecting members are symmetrically disposed on both sides of the buckle.

7. The extended structure for use with a tripod as claimed in claim 1, wherein the connecting member is detachably connected to the buckle.

8. The extended structure for use with a tripod as claimed in claim 7, wherein the buckle is provided with a screw hole, an end of the connecting member is provided with a screw, and the screw is matched with the screw hole.

9. The extended structure for use with a tripod as claimed in claim 1, wherein the buckle comprises:
a connecting plate provided with a through hole which is fixedly connected with the tripod;
a tension adjusting member fixed on the connecting plate for adjusting a size of the through hole, so as to adjust a connection tightness between the connecting plate and the tripod.

10. A tripod comprising:
a supporting leg;
a mounting seat fixed and supported by the supporting leg; and
the extended structure for use with the tripod as claim 1, and the buckle is fixed on the mounting seat.
